(19) United States
(12) Patent Application Publication
(10) Pub. No.: US 2016/0327460 A1
(43) Pub. Date: Nov. 10, 2016

(54) METHOD AND SUPPORT FOR STORING AND CONCENTRATING A NON-VOLATILE COMPOUND

(71) Applicant: ESPCI, Paris (FR)

(72) Inventors: PATRICK TABELING, PARIS (FR); FABRICE MONTI, SAULX LES CHARTREUX (FR); LAURA MAGRO, PARIS (FR)

(21) Appl. No.: 15/034,524

(22) PCT Filed: Nov. 7, 2014
(86) PCT No.: PCT/FR2014/052866

§ 371 Date: May 4, 2016

(30) Foreign Application Priority Data
Nov. 8, 2013 (FR) 1360987

(51) Int. Cl. G01N 1/40; B01L 3/00

(52) U.S. Cl. CPC G01N 1/405; B01L 3/5023; B01L 2400/0406; B01L 2300/069

(57) ABSTRACT

A method for storing and concentrating at least one non-volatile compound contained in a fluid. The fluid additionally includes at least one volatile compound. The fluid is injected into a porous substrate for at least one volatile compound. At least one non-volatile compound, at least by capillarity, is transported by at least one volatile compound. Each transported non-volatile compound is concentrated by injecting at least one volatile compound into or onto the porous substrate to move at least one non-volatile compound from one point of the porous substrate to another. For each step of injecting a volatile compound, each non-volatile compound is dried at one point of the porous substrate by evaporating each volatile compound.

### TECHNICAL FIELD OF THE INVENTION

The present invention relates to a method for storing and concentrating a non-volatile compound. It applies, in particular, to medical diagnosis systems wherein the number of samples is very small.

### STATE OF THE ART

The term “microfluidic system” refers to a system manipulating fluids wherein at least one of the characteristic dimensions is between 1 micrometer and 500 micrometers. These systems have the advantage of requiring a very small quantity of an analyte to operate.

The terms “reagent” refers to any compound likely to interact with an analyte. This interaction can be chemical, e.g. with an exchange of protons, an exchange of electrons, the forming and/or breaking of chemical bonds of covalent bonds, hydrogen bonds, disulfide bonds, or Van der Waals bonds type. This interaction can also be electrostatic, repulsive, or attractive. This interaction can be specific, e.g. with the formation of antigen-antibody complexes, the formation of enzyme-substrate complex, the hybridization of complementary DNA strands, or non-specific.

The term “volatile compound” refers to any compound wherein a large portion of the volume evaporates during the experiment times considered. The term “non-volatile compound” refers to any compound wherein the volume that evaporates during the experiment times considered is negligible.

Microfluidic systems are used increasingly in fields as varied as chemistry, biology, physics, analysis, and screening. Different types of these systems exist, in particular chips from the micromanufacture of glass, silicon, metal, polymers, or a combination of these materials.

In this type of microfluidic systems, microchannels can be etched in the substrate by any known method. A solid or thin-film part then covers the substrate, thus delimiting the geometry of the microchannels. The microchannels can also be obtained by molding an elastomer in a suitable mold and then positioned on a substrate. These microchannels can be arranged to form a network in which fluids circulate.

The flows are generated, most of the time, by external energy sources such as pumps for control of pressure and syringe-drivers acting on the flow-rate. A more autonomous microfluidic system is obtained by using the capillary forces and the wetting properties.

Document U.S. Pat. No. 7,695,687 illustrates an autonomous microfluidic system wherein the capillary forces make it possible to generate a flow.

In parallel with micromanufactured channels, a porous substrate, which has the advantage of naturally having a network of microchannels, can be used. This is the case, for example, of paper in which water flows spontaneously.

The recent technology of paper microfluidic systems applies particularly in the medical diagnosis field, since these systems can be deployed on a large scale and at a low cost. In these systems, a drop of fluid comprising at least one non-volatile compound is placed on a paper containing a reagent configured to react with at least one non-volatile compound. The medical tests performed using these systems give almost instantaneous results and are single-use.

However, one of the main drawbacks of these paper microfluidic systems is that a dry sample is normally thrown away. This drawback is particularly important when the sample has a small volume such as, for example, the case of a newborn's blood used in a medical diagnosis. In addition, the current microfluidic systems do not optimize the quantity of non-volatile compound, for example present in a sample, necessary to achieve a reaction between a reagent and at least one non-volatile compound. Secondly, the current systems store the samples in liquid form in microchannels or vessels.

Lastly, some systems try to retrieve an analysis by plunging a porous substrate comprising a dry analyte into a fluid comprising enzymes configured to digest the porous substrate. These systems have several disadvantages, the first being a possible pollution of the system by bacteria inhibiting the enzyme making the retrieval of the analyte more difficult, the second being that the time required to carry out this digestion is several hours, and the third being that the enzymes are expensive.

In particular, document FR 2 946 269 is known, the subject of which is a microfluidic device to transport a product from a product injection area to a product inlet area via a product channeling area. Because of this conveyance objective, the device envisages to minimize the effect of evaporating a solvent transporting the product during the conveyance. Therefore, the objective of this document is not to use a dry sample present on a porous substrate, but envisages a technical instruction of a transport solution with a sample.

Patent application EP 2 560 004 is also known, the subject of which is a device for detecting the presence of a compound in a fluid. In this context, the technical effect sought is to provoke a chemical reaction of a compound bound to a porous substrate in the presence of the compound to be detected so as to color the porous substrate, for example. This document does not stipulate a mechanism for transporting a non-volatile compound allowing satisfactory storage and restitution with regard to the constraints mentioned above.

Lastly, patent application WO 00/54309 is known, the subject of which is a mass spectrometry device intended to determine the mass of a target molecule to determine the nature of this molecule. This document does not allow an optimized storage of molecules in and/or on a porous substrate with regard to the constraints mentioned above.

### OBJECT OF THE INVENTION

The present invention aims to remedy all or part of these drawbacks.

To this end, the present invention envisages, according to a first aspect, a method for storing and concentrating at least one non-volatile compound contained in a fluid comprising in addition at least one volatile compound, which comprises:
an initial step of injecting the fluid into a porous substrate for at least one volatile compound;
a step of transporting at least one volatile compound, at least by capillarity, by at least one volatile compound; and
a step of concentrating each transported non-volatile compound comprising:
   at least one additional step of injecting at least one volatile compound into or onto the porous substrate such as to move at least one non-volatile compound from one point of the porous substrate to another; and,
   for each step of injecting a volatile compound, a step of drying each non-volatile compound at one point of the porous substrate carried out by evaporating each volatile compound.

Thanks to these provisions, it is possible to store and concentrate a non-volatile compound at a point of the porous substrate. This concentration makes it possible to carry out, at the point of the concentration, an optimum analysis of the dried non-volatile compound at this point. In particular, the additional injection of a volatile compound for concentrating a non-volatile compound is counter-intuitive because the volatile compound flows in the porous substrate.

In some embodiments, the method that is the subject of the present invention comprises, downstream from the concentration step, a step of reacting at least one non-volatile compound with at least one reagent, each said reagent being configured to react with each said non-volatile compound. These embodiments have the advantage of allowing, for example, an identification the presence of a non-volatile compound in the fluid injected into the porous substrate.

In some embodiments, the method that is the subject of the present invention comprises, upstream from the concentration step, a step of separating each non-volatile compound into a different point of the porous substrate by a differentiated movement of each non-volatile compound. The advantage of these embodiments is that they make it possible to perform a separate analysis on each non-volatile compound independently.

In some embodiments, the reaction step utilizes a plurality of reagents, each reagent being positioned at a different point of the porous substrate such that at least two reagents do not enter into contact with each other. These embodiments enable, in the case of reagents coloring on contact with a non-volatile compound, the presence of at least two non-volatile compounds to be separately identified.

In some embodiments, the reagent is configured so as to modify, during a reaction step, the transport properties of the non-volatile compound. These embodiments make it possible to keep in one point a non-volatile compound reacting with the reagent.

In some embodiments, the method that is the subject of the present invention comprises a plurality of additional steps of injecting a fluid into or onto the porous substrate so as to, successively, concentrate at the same point of the porous substrate different quantities of the same non-volatile compound. These embodiments make it possible to increase the quantity of a non-volatile compound at a point of the porous substrate.

In some embodiments, the method that is the subject of the present invention comprises a step of restituting at least one non-volatile compound from the porous substrate to a recipient, by a solvent in which said non-volatile compound dissolves passing through the porous substrate. The advantage of these embodiments is that they make it possible to retrieve a dried non-volatile compound.

In some embodiments, at least one portion of the porous substrate comprises a different fibrous density than the rest of the porous substrate. These embodiments have the advantage of retaining more or less of a non-volatile compound during the transport step according to the size of this volatile compound.

In some embodiments, the porous substrate comprises a density gradient of fibers along an axis of the porous substrate. These embodiments make it possible to sort each non-volatile compound according to the size of each of these non-volatile compounds.

In some embodiments, the porous substrate comprises a barrier over at least one portion of the surface of the porous substrate, the barrier being configured to be non-porous for at least one non-volatile compound, the porous substrate being configured to be porous for at least one volatile compound, including under the barrier. The advantage of these embodiments is that they make it possible to improve the concentration at a point of each non-volatile compound according to the positioning of the barrier. In addition, the fact that at least one volatile compound can flow under the barrier enables an accelerated evaporation of the volatile compound.

The present invention envisages, according to a second aspect, a support for storing and concentrating at least one non-volatile compound contained in a fluid comprising in addition at least one volatile compound, which comprises:
a substrate, porous for at least one volatile compound, including under a barrier; and
the barrier over at least one portion of the surface of the porous substrate, the barrier being configured to be non-porous for at least one non-volatile compound,
at least one non-volatile compound being thus concentrated by at least one volatile compound flowing in the porous substrate.

Thanks to these provisions, the non-volatile compound is spatially concentrated on the porous substrate according to the positioning of the barrier. In addition, the flowing of each volatile compound within the entire volume of the porous substrate enables a rapid concentration of each non-volatile compound.

In some embodiments, the barrier is positioned at least partially in the porous substrate.

In some embodiments, the barrier is obtained by solidifying a polymer or a resin on the surface of the porous substrate. These embodiments have the advantage of making it possible to produce a barrier, on the surface or over a partial thickness of the porous substrate, at low cost.

In some embodiments, the barrier is obtained by melting then solidifying wax on the porous substrate. These embodiments have the advantage of making it possible to produce a barrier penetrating into one portion of the volume of the porous substrate.

In some embodiments, the barrier is an adhesive tape that is non-porous for at least one non-volatile compound. The advantage of these embodiments is that they make it possible to install a barrier at low cost on the surface or in a partial thickness of the porous substrate.

In some embodiments, the barrier is obtained by a local contrast in the wetting property of the porous substrate. These embodiments have the advantage of making it possible to produce a barrier without needing to add additional material on the porous substrate.

In some embodiments, the barrier forms a transport channel for each non-volatile compound. These embodiments have the advantage of enabling the movement of at least one non-volatile compound on the surface of the porous substrate.

In some embodiments, the transport channel is configured:
such that each non-volatile compound is transported, at least by capillarity, by at least one volatile compound along the channel, and
such that each non-volatile compound is concentrated in different points of the porous substrate by evaporation of each volatile compound.

The advantage of these embodiments is that they make it possible to separate each non-volatile compound on the porous substrate.

In some embodiments, the porous substrate comprises, in at least one point, a reagent configured to react with at least one non-volatile compound. These embodiments have the advantage of enabling, for example, the detection of a non-volatile compound by the reaction between the reagent and this non-volatile compound.

In some embodiments, the porous substrate comprises a plurality of reagents such that at least two reactive compounds do not enter into contact with each other. The advantage of these embodiments is that, in the case of reagents configured to adopt a certain color if a certain non-volatile compound is detected, the two colors do not overlap, so as to enable an easier identification of the presence of each non-volatile compound that has reacted.

In some embodiments, the barrier is configured to enable the binding of at least one other porous substrate so as to put at least two porous substrates in contact. The advantage of these embodiments is that they make it possible to transport a non-volatile compound from one porous substrate to another.

In some embodiments, at least one other porous substrate bound to the support has a different fibrous density to the fibrous density of the porous substrate. These embodiments have the advantage of making it possible to sort non-volatile compounds according to the size of these compounds, even to filter non-volatile compounds.

In some embodiments, the barrier is configured to increase in thickness along an axis of the porous substrate so as to realize the transversal concentration of each non-volatile compound in the porous substrate. These embodiments make it possible to concentrate a non-volatile compound laterally and transversally in the porous substrate.

According to a third aspect, the present invention envisages a device comprising:
a support that is the subject of the present invention; and
a means of injecting a fluid onto the porous substrate, configured to perform a plurality of injections so as to, successively, concentrate at the same point of the porous substrate different quantities of the same non-volatile compound.

Thanks to these provisions, a non-volatile compound can be concentrated in the same point of the porous substrate. In particular, this aspect makes it possible, with a single injection of non-volatile compound, to increase the concentration at a point of the porous substrate by successively injecting the volatile compound.

According to a fourth aspect, the present invention envisages a device comprising:
a support that is the subject of the present invention; and
a means of injecting a fluid onto the porous substrate configured to perform a plurality of injections of different fluids, including at least one fluid that comprises at least one non-volatile compound, onto a porous substrate so as to concentrate different non-volatile compounds at different points of the porous substrate, or so as to move at least one non-volatile compound from one point of the porous substrate to another.

Thanks to these provisions, several non-volatile compounds can be concentrated at different points on the porous substrate.

In some embodiments, the device that is the subject of the present invention comprises a means of transporting at least one non-volatile compound from the porous substrate to a recipient, by a solvent in which said non-volatile compound dissolves passing through the porous substrate. These embodiments make it possible to retrieve a dried non-volatile compound in the porous substrate.

In some embodiments, the device that is the subject of the present invention comprises a means of selectively restituting a non-volatile compound by a solvent in which the compound dissolves passing through the point in which the non-volatile compound is concentrated. These embodiments have the advantage of enabling the selective retrieval of a non-volatile compound.

The present invention envisages, according to a fifth aspect, a method of transporting and restituting at least one dried non-volatile compound in a porous substrate, which comprises:
a step of injecting a solvent, in which each dried non-volatile compound dissolves, into the porous substrate;
a step of restituting each non-volatile compound into at least one microchannel, which comprises:
   a step of putting the porous substrate into contact with each said microchannel;
   a step of reducing the pressure in each said microchannel; and
   a step of transporting at least one portion of at least one non-volatile compound present in the porous substrate towards each said microchannel.

Reducing the pressure in each microchannel makes it possible, by flowing, to attract the fluid injected from the porous substrate towards each microchannel. These provisions enable a dried non-volatile compound on a porous substrate to be retrieved and this compound to be used once it has entered each microchannel.

According to a sixth aspect, the present invention envisages a method of transporting and storing at least one non-volatile compound present in a fluid, which comprises:
a step of injecting fluid into at least one microchannel; and
a step of storing each non-volatile compound in a porous substrate, which comprises:
   a step of putting the porous substrate into contact with at least one microchannel;
   a step of altering the pressure of the fluid injected into at least one microchannel so as to cause the fluid to flow from the microchannel towards the porous substrate;
   a step of transporting at least one portion of at least one non-volatile compound from each said microchannel towards the porous substrate; and
   a step of drying each non-volatile compound in the porous substrate.

These provisions make it possible to store, on a porous substrate, at least one non-volatile compound present in a microchannel in a dried form. This dried non-volatile compound can be subsequently restituted to be used in other applications.

In some embodiments, the transport step comprises a step of coupling the porous substrate with at least one microchannel. The advantage of these embodiments is that they make it possible to prevent interruption of the transport of at least one non-volatile compound in the case where the porous substrate and at least one microchannel become detached.

In some embodiments, the method that is the subject of the present invention comprises, upstream from the transport step, a step of opening at least one microchannel so as to enable a portion of the porous substrate to be inserted into said microchannel. These embodiments have the advantage of making it possible to prevent pollution of the fluid in at least one microchannel by contact with the ambient air before each of these microchannels is put into contact with the porous substrate.

In some embodiments, the method that is the subject of the present invention comprises upstream from the injection step, a step of inserting the porous substrate into at least one microchannel. The advantage of these embodiments is that they make it possible to concentrate at least one non-volatile compound on the porous substrate in a microchannel.

In some embodiments, the method that is the subject of the present invention comprises, upstream from the drying step, a step of spatially concentrating each non-volatile compound in the porous substrate. These embodiments have the advantage of making it possible to optimize the carrying out of an analysis on a non-volatile compound because of the concentration of this non-volatile compound at one point of the porous substrate.

In one embodiment, the step of spatially concentrating each non-volatile compound is carried out at different points of the porous substrate. These embodiments have the advantage of enabling the separation of each non-volatile compound in the porous substrate.

In some embodiments, the fluid also comprises a volatile compound configured to make it possible to transport each non-volatile compound and to evaporate during the drying step. The advantage of these embodiments is that they enable a better carrying capacity for each non-volatile compound.

In some embodiments, the method that is the subject of the present invention comprises a step of selectively restituting a non-volatile compound by a solvent in which the compound dissolves passing through the point in which the non-volatile compound is concentrated. These embodiments make it possible to retrieve each non-volatile compound independently.

In some embodiments, the restitution step comprises a step of dividing the porous substrate into zones in which at least one non-volatile compound is concentrated. The advantage of these embodiments is to improve a selective restitution of at least one non-volatile compound by avoiding pollution by other non-volatile compounds.

According to a seventh aspect, the present invention envisages a method of transporting, storing and restituting at least one non-volatile compound present in a fluid, which comprises:
a step of injecting fluid into at least one microchannel;
a step of storing each non-volatile compound in a porous substrate, which comprises:
   a step of putting the porous substrate into contact with at least one microchannel;
   a step of altering the pressure of the fluid injected into at least one microchannel so as to cause the fluid to flow from the microchannel towards the porous substrate;
   a step of transporting at least one portion of at least one non-volatile compound from each said microchannel towards the porous substrate; and
   a step of drying each non-volatile compound in the porous substrate;
a step of injecting a solvent, in which each non-volatile compound dissolves, into the porous substrate; and
a step of restituting each non-volatile compound into at least one microchannel, which comprises:
   a step of putting the porous substrate into contact with each said microchannel;
   a step of reducing the pressure in each said microchannel; and
   a step of transporting at least one portion of at least one non-volatile compound present in the porous substrate towards each said microchannel.

As the particular features, advantages and aims of this method are similar to those of the transport and storage method and the method of transport and restitution that are the subjects of the present invention, they are not repeated here.

The particular characteristics of the various aspects of the present invention are intended to be combined to give other embodiments of the methods and devices that are the subjects of the present invention.

### BRIEF DESCRIPTION OF THE FIGURES

Other advantages, aims and particular features of the present invention will become apparent from the description that will follow, made, as a non-limiting example, with reference to drawings included in an appendix, wherein:

FIG. 1 represents, in the form of a logical diagram, steps in a particular embodiment of the transport, storage and restitution method that is the subject of the present invention;

FIG. 2 represents, in the form of a logical diagram, steps in a particular embodiment of the storage and concentration method that is the subject of the present invention;

FIG. 3 represents, schematically, a particular embodiment of a storage and concentration support that is the subject of the present invention;

FIG. 4 represents, schematically, a particular embodiment of a storage and concentration device that is the subject of the present invention;

FIG. 5 represents, schematically, a particular embodiment of a storage and concentration device that is the subject of the present invention;

FIGS. 6 to 8 represent particular embodiments of a microchannel in which the number of contact zones and injection-retrieval zones differ;

FIGS. 9 to 11 represent a particular embodiment of a microchannel utilized, for example, by the method represented in FIG. 1;

FIG. 12 represents a particular embodiment of a manual system for regulating the internal pressure of a microchannel;

FIGS. 13 and 14 represents two particular opening modes of a microchannel and putting a porous substrate into contact;

FIGS. 15 and 16 represent particular embodiments of a microchannel;

FIG. 17 represents a particular embodiment of a transfer of liquid from a porous substrate to a microchannel;

FIG. 18 represents a microchannel into which a porous substrate has been inserted;

FIGS. 19 to 22 represent the movement of a non-volatile compound through a porous substrate according to the characteristics of the non-volatile compound;

FIGS. 23 and 24 represent, in two graphs, the change in the concentration of a non-volatile compound on a porous substrate as a function of particular injection parameters;

FIGS. 25 to 30 represent effects, in terms of spatial concentration, of different types of barriers of a porous substrate;

FIGS. 31 to 34 represent different types of barriers; and

FIG. 35 represents a microchannel realized from barriers positioned on a porous substrate.

### DESCRIPTION OF EXAMPLES OF REALIZATION OF THE INVENTION

The present description is given as a non-limiting example.

It is noted that the figures are not to scale.

It is noted that the term “one, a; an” is used in the sense of “at least one”.

The porous substrates utilized in the following embodiments are formed, for example, by a network of fibers with a characteristic diameter of 20 micrometers, forming polydispersed pores that can have an average transversal diameter of five to ten micrometers. “Porous substrate” means here, for example, a sheet of paper having a thickness of 200 micrometers and a centimetric width.

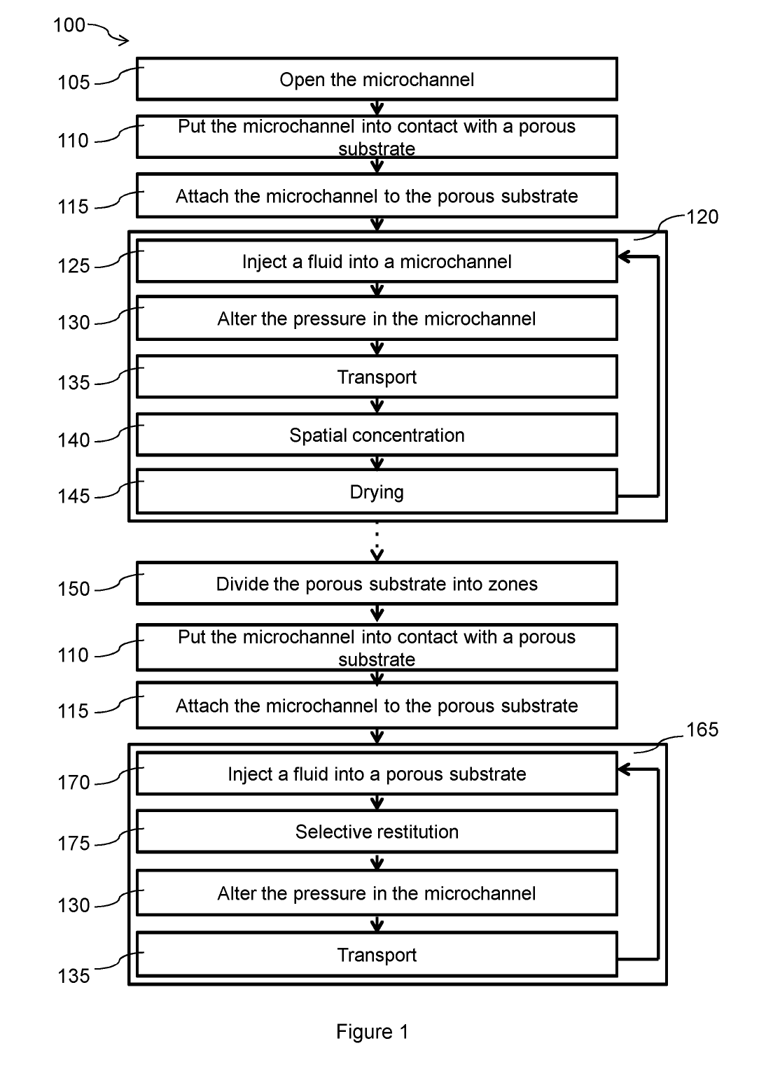

FIG. 1 shows a particular embodiment of the transport, storage and restitution method 100. This method 100 comprises:
a step 105 of opening at least one microchannel so as to enable a portion of the porous substrate to be inserted into each said microchannel;
a step 110 of putting the porous substrate into contact with at least one microchannel;
a step 115 of coupling the porous substrate with at least one microchannel;
a step 120 of storing each non-volatile compound in a porous substrate, which comprises:
   a step 125 of injecting fluid into at least one microchannel;
   a step 130 of altering the pressure of the fluid injected into at least one microchannel;
   a step 135 of transport;
   a step 140 of spatially concentrating each non-volatile compound in the porous substrate; and
   a step 145 of drying each non-volatile compound in the porous substrate;
a step 150 of dividing the porous substrate into zones in which at least one non-volatile compound is concentrated;
a step 110 of putting the porous substrate into contact with each said microchannel;
a step 115 of coupling the porous substrate with at least one microchannel;
a step 165 of restituting each non-volatile compound into at least one microchannel, which comprises:
   a step 170 of injecting a fluid, in which at least one non-volatile compound dissolves, into the porous substrate;
   a step 175 of selectively restituting a non-volatile compound;
   a step 130 of changing the pressure in each said microchannel; and
   a step 135 of transport.

The step 105 of opening at least one microchannel so as to enable a portion of the porous substrate to be inserted into said microchannel is carried out, for example, by utilizing a sectioning means. This sectioning means can be, for example, a pair of scissors. This opening step 105 makes it possible in particular to prevent a volatile compound contained in the microchannel from evaporating too quickly. A particular embodiment of this opening step 105 is detailed, below, with reference to FIG. 10.

The step 110 of putting the porous substrate into contact with at least one microchannel is carried out, for example, by inserting the porous substrate into an opening in a microchannel. The application envisaged consists mainly of the storage and restitution of a non-volatile compound. The benefit of inserting a porous substrate into a microchannel having two openings, for example, is to make it possible to concentrate on the porous substrate the non-volatile compounds entered into the microchannel. In this way, the retrieval of non-volatile compounds is made easier because the non-volatile compounds are concentrated. A particular embodiment of a device corresponding to this contacting step 110 is detailed, below, with reference to FIG. 18. The contacting step 110 is carried out, for example, by juxtaposing an opening of at least one microchannel and the porous substrate.

The step 115 of coupling the porous substrate with at least one microchannel is carried out, for example, by utilizing fixing clips configured to press the porous substrate against an open microchannel. A particular embodiment of this coupling step 115 is detailed, below, with reference to FIG. 11.

The step 125 of injecting fluid into at least one microchannel formed in a non-porous material for each non-volatile compound is carried out, for example, by utilizing a syringe depositing in an opening of each said microchannel a fluid comprising at least one non-volatile compound. In some variants, this method 100 comprises a plurality of steps 125 of injecting fluid into at least one microchannel so as to, successively, concentrate at the same point of the porous substrate different quantities of the same non-volatile compound. In other variants, this method 100 comprises a plurality of steps of injecting 125 different fluids, at least one of which comprises at least one non-volatile compound, into at least one microchannel so as to concentrate different non-volatile compounds at different points of the porous substrate, or so as to move at least one non-volatile compound from one point of the porous substrate to another.

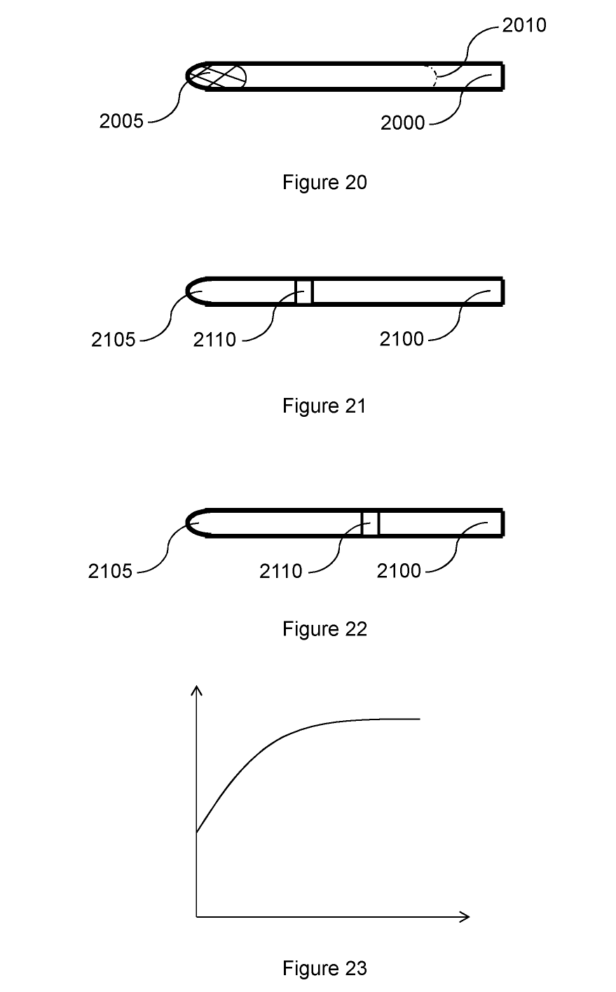

The additional injection of a fluid comprising a non-volatile compound present during a preceding injection step 125 enables this non-volatile compound to be concentrated in the porous substrate. The injection 125 of a fluid comprising at least one volatile compound, for example a solvent, makes it possible to move at least one non-volatile compound. This effect can be particularly advantageous in the context of a porous substrate comprising a reagent configured to react with a specific non-volatile compound. In this way, it is possible to move a non-volatile compound until a chemical reaction is caused without in any way causing a chemical reaction with other non-volatile compounds, which have a lower movement speed in the porous substrate. The effects of these additional injections are described, below, in the descriptions of FIGS. 20 to 24.

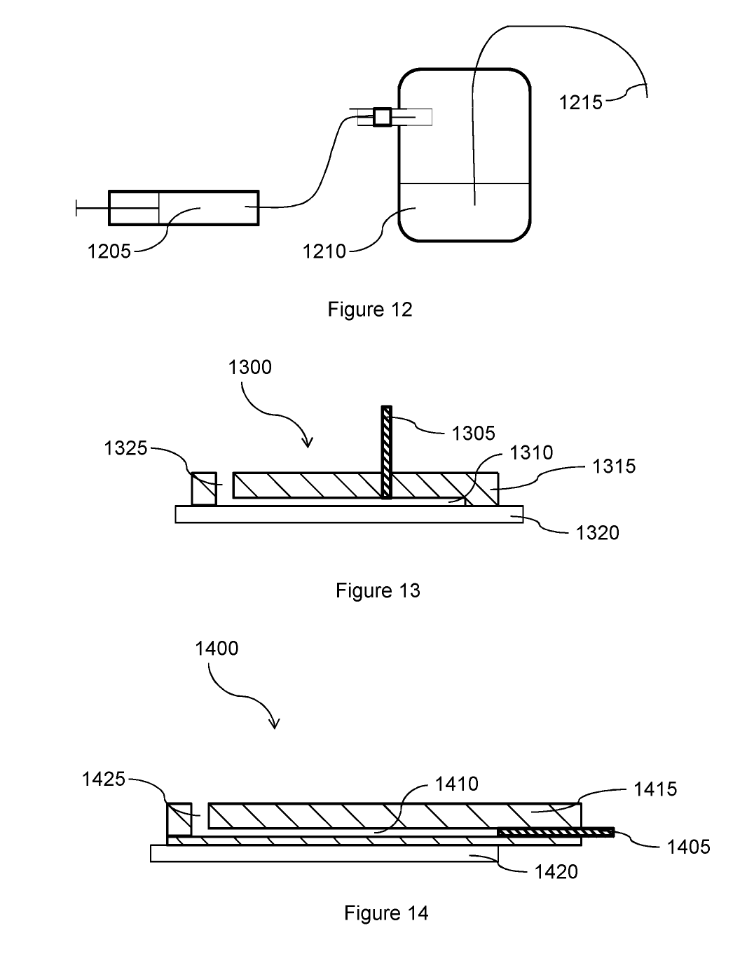

The step of altering 130 the pressure of the fluid injected into at least one microchannel so as to cause the fluid to flow from the microchannel towards the porous substrate, or a fluid to flow from the porous substrate towards the microchannel, is carried out, for example, by utilizing a syringe-driver type of syringe. By increasing the pressure in the microchannel, the fluid is pushed from the microchannel towards the porous substrate. By reducing the pressure in the microchannel, the fluid is pushed from the porous substrate towards the microchannel. A device enabling this pressure alteration step 130 is detailed, below, in the description of FIG. 12.

The step 135 of transporting each non-volatile compound in the porous substrate, for each non-volatile compound, is carried out by capillarity.

The spatial concentration step 140 is carried out by evaporating each volatile compound transporting at least one non-volatile compound. The concentration at least one non-volatile compound at one point of the porous substrate can be improved by an additional injection of volatile compound making it possible to transport portions of the non-volatile compound that had not been moved sufficiently before the drying of the volatile compound. In addition, the spatial concentration of each non-volatile compound is carried out in different points of the porous substrate by evaporation of each non-volatile compound.

The step of dividing 150 the porous substrate into zones in which at least one non-volatile compound is concentrated is carried out, for example, by sectioning the porous substrate into different zones. In some variants, a barrier passing through the thickness and width of the porous substrate makes it possible to divide the porous substrate into zones.

The contacting step 110 is carried out, for example, by juxtaposing an opening of at least one microchannel and the porous substrate.

The step 115 of coupling the porous substrate with at least one microchannel is carried out, for example, by utilizing fixing clips configured to press the porous substrate against an open microchannel.

The step of injecting 170 a fluid into or onto the porous substrate is carried out, for example, by utilizing a syringe depositing a fluid comprising at least one non-volatile compound onto or into the porous compound.

The step of selectively restituting 175 a non-volatile compound is carried out by a solvent in which the compound dissolves passing through a zone that comprises a point in which a non-volatile compound is concentrated.

The step of altering 130 the pressure of the fluid injected into at least one microchannel so as to cause the fluid to flow from the porous substrate towards the microchannel is carried out, for example, by utilizing a syringe-driver type of syringe. By reducing the pressure in the microchannel, the fluid is drawn from the porous substrate towards the microchannel.

The step 135 of transporting at least one non-volatile compound from the porous substrate towards at least one microchannel is carried out by a solvent in which said non-volatile compound dissolves passing through the porous substrate. This transport is carried out, for example, by capillarity.

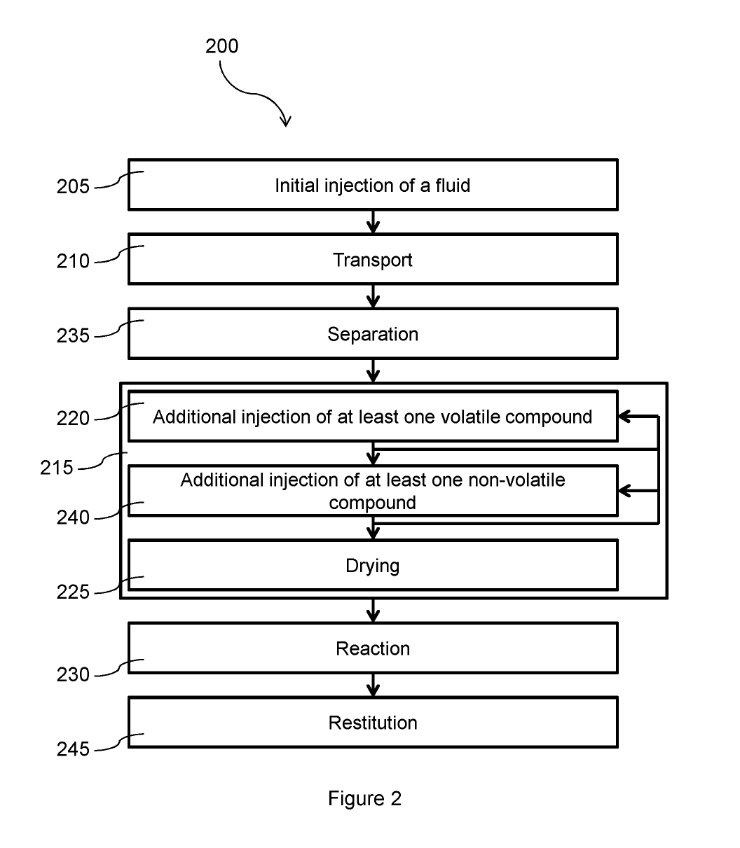

FIG. 2 shows a particular embodiment of the storage and concentration method 200. This method 200 comprises:
an initial step 205 of injecting the fluid into a porous substrate for at least one volatile compound;
a step 210 of transporting at least one non-volatile compound, at least by capillarity, by at least one volatile compound; and
a step 235 of separating each non-volatile compound into a different point of the porous substrate by a differentiated movement of each non-volatile compound;
a step 215 of concentrating each transported non-volatile compound comprising:
   at least one additional step 220 of injecting at least one volatile compound into or onto the porous substrate such as to move at least one non-volatile compound from one point of the porous substrate to another;
   a plurality of additional steps 240 of injecting a fluid into the porous substrate so as to, successively, concentrate at the same point of the porous substrate different quantities of the same non-volatile compound; and,
   for each step of injecting a volatile compound, a step 225 of drying each non-volatile compound at one point of the porous substrate carried out by evaporating each volatile compound;
a step 230 of reacting at least one non-volatile compound with at least one reagent, each said reagent being configured to react with each said non-volatile compound; and
a step 245 of restituting at least one non-volatile compound from the porous substrate to a recipient, by a solvent in which said non-volatile compound dissolves passing through the porous substrate.

The step 205 of injecting fluid into at least one microchannel formed in a non-porous material for each non-volatile compound is carried out, for example, by utilizing a syringe depositing into or onto a porous substrate a fluid comprising at least one non-volatile compound.

The step of transporting 210 the fluid in or on the porous substrate is carried out, for example, by capillarity. During this transport step 210, at least one volatile compound transports at least one non-volatile compound by capillarity through the porous substrate. In some variants, the porous substrate comprises a density gradient of fibers along an axis longitudinal to the flow so as to progressively retain the non-volatile compounds according to the size of these non-volatile compounds. In other variants, the surface of the porous substrate comprises a barrier configured to be non-porous for at least one non-volatile compound, the porous substrate being configured to be porous for at least one volatile compound, including under the barrier.

In some preferential variants, the volatile compound disperses in the thickness of the porous substrate so as to increase the volume and the evaporation surface of the volatile compound. Conversely, the non-volatile compound is retained at the surface and only moves on the surface of the porous substrate.

The separation step 235 is carried out, for example, by the difference in flow speed of at least two non-volatile compounds. This is because each non-volatile compound has particular characteristics that influence this non-volatile compound's movement speed in the porous substrate. This movement is also limited by the length of time required for the evaporation of each volatile compound in which the non-volatile compound is dissolved. Thus, each non-volatile compound moves to a certain point of the porous substrate during the length of time required for the evaporation of the solvent. If two non-volatile compounds have different movement speeds, the two non-volatile compounds separate during this separation step 235.

The additional injection step 220 is carried out, for example, by utilizing a syringe depositing into or onto a porous substrate a fluid comprising at least one volatile compound. Each additional injection step 220 makes it possible to move at least one non-volatile compound dissolving in at least one volatile compound before being transported by each volatile compound.

The additional injection step 240 is carried out, for example, by utilizing a syringe depositing into or onto a porous substrate a fluid comprising at least one non-volatile compound. Each additional injection step 240 makes it possible to increase the quantity of at least one non-volatile compound in the porous substrate, each non-volatile compound injected in this way then being able to be concentrated at a point of the porous substrate.

The drying step 225 is carried out, for example, by evaporation of each volatile compound present on or in the porous substrate.

The reaction step 230 is carried out, for example, by depositing a reagent at a point of the porous substrate. This reagent is configured to react with at least one non-volatile compound. When a non-volatile compound is transported over a point where the reagent is placed, the reagent and the non-volatile compound react. In some variants, a plurality of reagents is positioned at different points of the porous substrate. At least one reagent is configured to modify the movement properties of at least one non-volatile compound so as to, for example, bind a non-volatile compound to a reagent.

The restitution step 245 is carried out by a solvent in which the compound dissolves passing through a point that comprises a concentrated non-volatile compound. The solvent is then, for example, drawn in by a microchannel whose pressure is reduced so as to cause the solvent to flow from the porous substrate towards the microchannel.

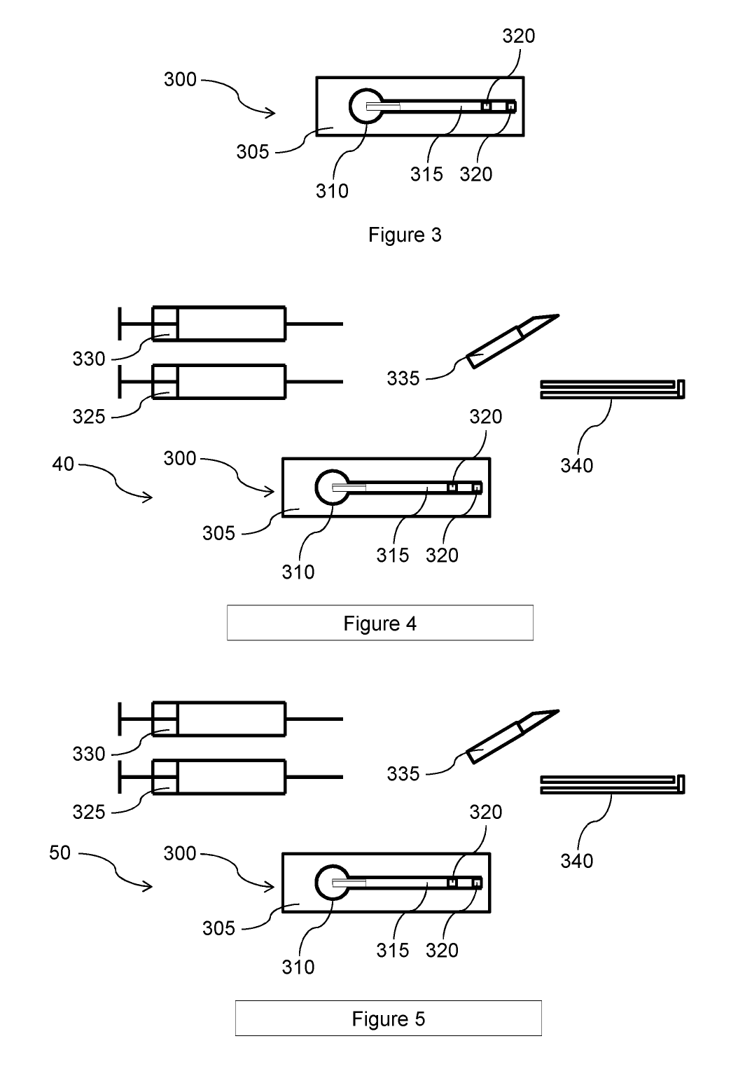

FIG. 3 shows a particular embodiment of the storage and concentration support 300 that is the subject of the present invention. This support 300 comprises:
a substrate 305, porous for at least one volatile compound, including under a barrier 310, which comprises a plurality of reagents 320 configured to react with at least one non-volatile compound, and
the barrier 310 over at least one portion of the surface of the porous substrate, the barrier being configured to be non-porous for at least one non-volatile compound,
at least one non-volatile compound being thus concentrated by at least one volatile compound flowing in the porous substrate.

The porous substrate 305 is, for example, a sheet of paper on which a barrier 310 is positioned.

This barrier 310 is, for example, formed with wax deposited on the porous substrate 305 then melted so as to penetrate the porous substrate 305. This barrier 310 forms, on and in the porous substrate 305, a transport channel 315 for at least one volatile compound comprising at least one non-volatile compound.

The transport channel 315 is configured:
such that each non-volatile compound is transported, at least by capillarity, by at least one volatile compound along the channel 315, and
such that each non-volatile compound is concentrated in different points of the porous substrate 305 by evaporation of each volatile compound.

Each non-volatile compound has different movement properties over the porous substrate 305 depending upon the characteristics specific to each non-volatile compound. The differences in movement speed over the porous substrate 305 of each non-volatile compound cause the concentration in different points of each non-volatile compound according to the time required for each volatile compound to evaporate.

The barrier 310 is configured to enable the binding of at least one other porous substrate, not shown, so as to put at least two porous substrates in contact. This barrier 310 is, for example, melted on the surface so as to bond the other porous substrate to the barrier 310. The other porous substrate has a different fibrous density to the fibrous density of the initial porous substrate 305.

In some preferential variants, the volatile compound disperses in the thickness of the porous substrate so as to increase the volume and the evaporation surface of the volatile compound. Conversely, the non-volatile compound is retained at the surface by the barrier.

FIG. 4 shows an embodiment of a storage and concentration device 40 that is the subject of the present invention. This device 40 comprises:
a support 300 as described in FIG. 3; and
a means 325 of injecting a fluid, onto or into the porous substrate 305, configured to perform a plurality of injections so as to, successively, concentrate at the same point of the porous substrate 305 different quantities of the same non-volatile compound;
a means 330 of transporting at least one non-volatile compound from the porous substrate 305 to a recipient 340; and
a means 335 of selectively restituting a non-volatile compound.

The injection means 325 is, for example, a syringe. This syringe makes it possible to perform a plurality of injections of a non-volatile compound into or onto the porous substrate 305. This non-volatile compound, whether it is transported by a volatile compound or not, is transported over the porous substrate 305 before drying at a point of the porous substrate 305.

The transport means 330 is, for example, a syringe configured to inject a solvent, in which at least one non-volatile compound dissolves, into the porous substrate 305. In order to transport at least one non-volatile compound towards a recipient 340, such as a microchannel, the porous substrate 305 is put into contact with the microchannel. A means of reducing the internal pressure, not shown, of the microchannel makes it possible to cause the solvent compound comprising at least one non-volatile compound to flow from the porous substrate 305 towards the microchannel.

The selective restitution means 335 is, for example, a pair of scissors allowing the porous substrate 305 to be cut according to the position of each point where a non-volatile compound is concentrated. The injection of a solvent into each of the cut portions enables the selective restitution of at least one non-volatile compound.

FIG. 5 shows an embodiment of a storage and concentration device 50 that is the subject of the present invention. This device 50 comprises:
a support 300 as described with regard to FIG. 3; and
a means 325 of injecting a fluid onto or into the porous substrate 305 configured to perform a plurality of injections of different fluids, of which at least one fluid comprises at least one non-volatile compound, onto a porous substrate 305 so as to concentrate different non-volatile compounds at different points of the porous substrate 305, or so as to move at least one non-volatile compound from one point of the porous substrate to another.
a means 330 of transporting at least one non-volatile compound from the porous substrate 305 to a recipient 340; and
a means 335 of selectively restituting a non-volatile compound.

The injection means 325 is, for example, a syringe. This syringe makes it possible to perform a plurality of injections of at least one non-volatile compound into or onto the porous substrate 305. Each non-volatile compound, whether it is transported by a volatile compound or not, is transported over the porous substrate 305 before drying at a point of the porous substrate 305.

The transport means 330 is, for example, a syringe configured to inject a solvent, in which at least one non-volatile compound dissolves, into the porous substrate 305. In order to transport at least one non-volatile compound towards a recipient 340, such as a microchannel, the porous substrate 305 is put into contact with the microchannel. A means of reducing the internal pressure, not shown, of the microchannel makes it possible to cause the solvent comprising at least one non-volatile compound to flow from the porous substrate 305 towards the microchannel.

The selective restitution means 335 is, for example, a pair of scissors allowing the porous substrate 305 to be cut according to the position of each point where a non-volatile compound is concentrated. The injection of a solvent into each of the cut portions enables the selective restitution of at least one non-volatile compound.

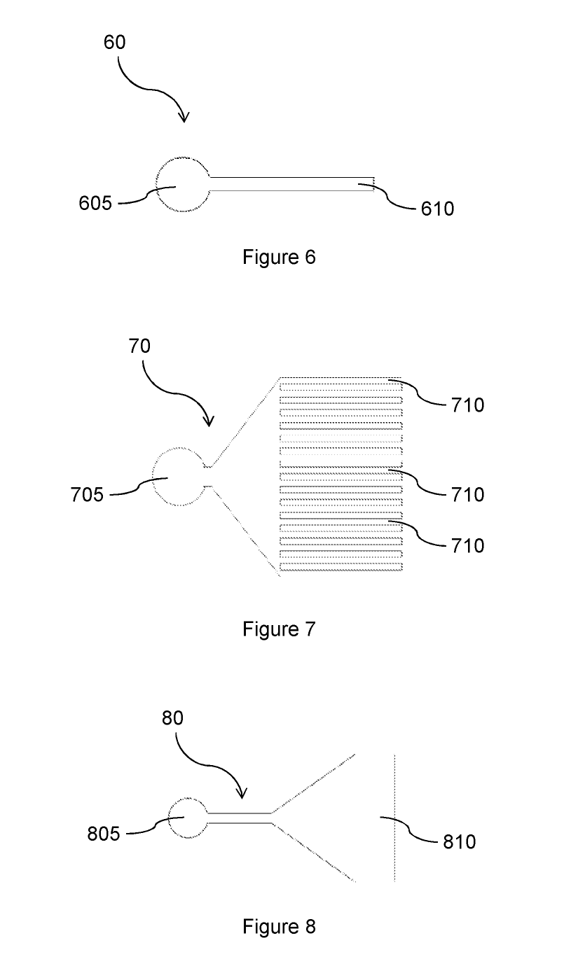

FIG. 6 shows a first embodiment of a microchannel 60 seen from above. This microchannel 60 comprises a means 605 of receiving a fluid, this fluid can be poured into the reception means 605 by a tank comprising in variants a system of controlling microfluidic flows in the reception means 605. This microchannel 60 also comprises a contact zone 610 configured to be placed in contact with a porous substrate, such as a sheet of paper for example.

The microchannels can be produced by a step of shaping a material. For example, this shaping step is carried out by:
etching;
micro-machining glass or silicon; or
molding with polymers: thermoforming or hot molding, polymer ablation, or polymer molding.

Depending on the technique used, the material utilized can be any type of polymer, for example polymers such as polystyrene (PS), polycarbonate (PC), polyvinyl chloride (PVC), cyclic olefin copolymers (COC), poly(methyl methacrylate) (PMMA), thermoset polyester (TPE), polyurethane methacrylate (PUMA), or acrylonitrile butadiene styrenes.

The material can also be chosen from the photocurable or photosensitive liquids or adhesives, for example Norland Optical Adhesive (“NOA”) (registered trademarks).

Once the material has been shaped, the material is positioned on a layer of a flat substrate. The molded material is positioned such that the indentation, created by the molding, etching or machining, forms a microfluidic channel on the flat substrate side.

FIG. 7 shows a second embodiment of a microchannel 70 seen from above. In this second embodiment of the microchannel 70, the microchannel 70 comprises a plurality of contact zones 710.

FIG. 8 shows a third embodiment of a microchannel 80 seen from above. In this third embodiment of the microchannel 80, the microchannel 80 comprises a contact zone 810 whose width increases as it gets farther from a means 805 of receiving a fluid.

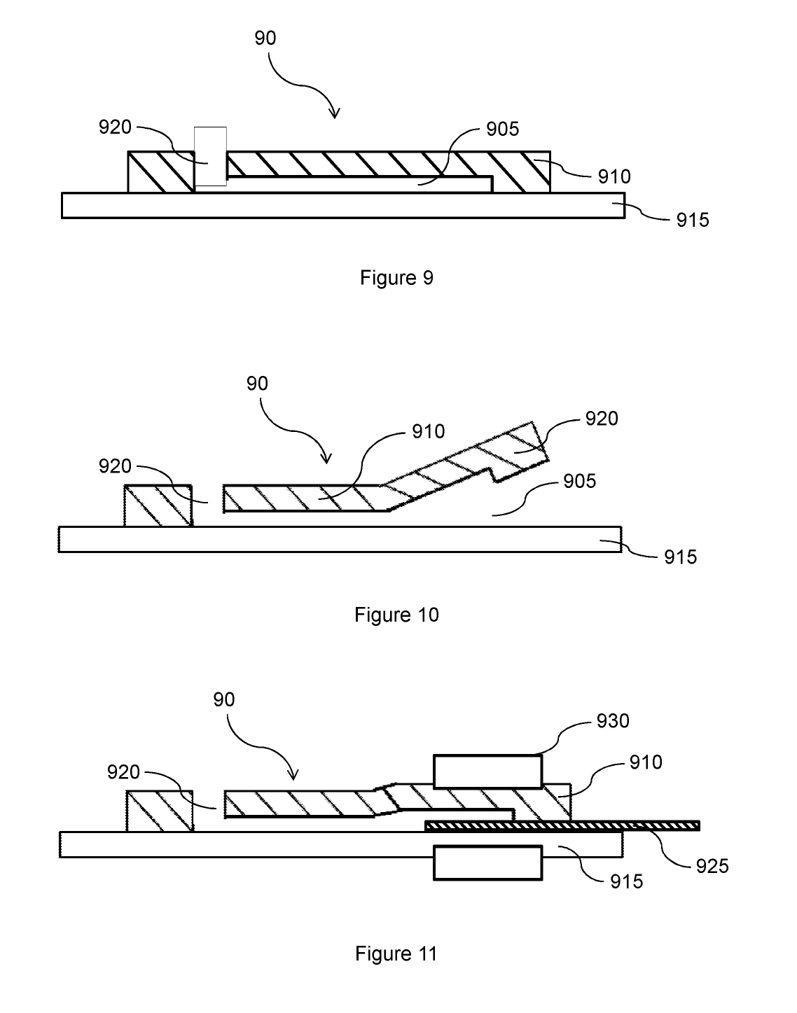

FIG. 9 shows a first cross-section view of a first particular embodiment of a microchannel 90. This microchannel 90 is produced, for example, according to one of the techniques described in FIG. 6. The cavity 905 formed between the processed material 910 and the substrate 915 acts as a duct. A fluid can be deposited, e.g. by flowing, at the opening of this cavity 905. The microchannel 90 is thus formed at the interface of two layers of material, at least one of the two being a substrate. The volume of the microchannel is contained in the indentation formed between the substrate and the other material.

FIG. 10 shows a second cross-section view of the microchannel 90 described in FIG. 9. In this FIG. 10, a portion of the material 910 processed and then placed on the substrate 915 is deformed by applying pressure on one extremity 920 of the microchannel 90 formed by the material 910 so as to detach the material 910 from the substrate 915. In some variants, the material 910 forming the extremity 920 of the microchannel 90 is connected to the rest of the material 910 by a hinge. In other variants, the material 910 is a shape memory material and resumes an initial position in contact with the substrate 915 when the pressure is released. In other variants, the extremity 920 of the microchannel 90 formed by the material 910 can be fastened to the substrate 915.

FIG. 11 shows a third cross-section view of the microchannel 90 described in FIGS. 9 and 10. In this FIG. 11, a porous substrate 925 is introduced into contact with the microchannel 90 by inserting the porous substrate 925 between the substrate 915 and the material 910 forming the microchannel 90. Once the porous substrate 925 is inserted, the detached portion of the material 910 and the substrate 915 are forced into contact with the porous substrate 925 by a fixing clip 930 surrounding the substrate 915, on the one hand, and the material 910, on the other hand, at the location of the insertion of the porous substrate 925.

The porous substrate 925 consists, for example, of one or more sheets of paper of cellulose, nitrocellulose, or cellulose acetate type, supplemented or not by other additives; a filter paper; a textile fabric; glass fibers; and, generally, any porous medium in which liquid flows by capillarity.

Once the porous substrate 925 is put into contact with the microchannel 90, and depending on the pressure in the microchannel 90, either a fluid contained in the microchannel 90 migrates towards the porous substrate 925, or a fluid contained in the porous substrate 925 migrates towards the microchannel 90.

The flow of liquid in the porous substrate 925 can be controlled by the shape of the substrate, by solid barriers formed in situ, e.g. hydrophobic wax, resin or polymers, by a wetting contrast, e.g. silanization, alkyl ketene dimer, known as “AKD”, treatment, or any other technique for controlling flows in a porous medium. Dipping a paper in an AKD bath causes the chemical coupling of this molecule, which then makes the paper, naturally hydrophilic, hydrophobic. Plasma processing through a mask made of metal makes it possible to attack the coupled chemical structure and to locally get back the hydrophilic character of the paper. There are thus channels designated by a hydrophilic-hydrophobic wetting contrast, a technique similar to silanization coupled with UV insolation.

FIG. 12 shows a cross-section view of a manual system for varying the internal pressure of a microchannel. This pressure variation system comprises a syringe 1205, a tank 1210, and a means 1215 of connection between a fluid contained in the tank 1210 and the microchannel. When a user presses on the moving portion of the syringe 1205, the fluid or gas contained in this syringe 1205 is injected into the tank 1210, increasing the pressure in this tank 1210. The rising internal pressure of the tank 1210 results in a portion of the fluid being evacuated towards the microchannel. The pressure therefore increases in the microchannel until the fluid contained in the microchannel is pushed towards a porous substrate that happens to be in contact with the microchannel. When the user pulls on the moving portion of the syringe 1205, the pressure in the tank 1210 is reduced and the process is reversed. In some variants, the pressure of the microchannel is controlled by pressure controllers, syringe-drivers, or other flow control systems.

FIG. 13 shows a cross-section view of a particular embodiment of a microchannel 1300. In this embodiment, a porous substrate 1305 is inserted into a cavity 1310 formed between a processed material 1315 and a substrate 1320 by an opening in the material 1315. This opening is realized by cutting the material 1315.

FIG. 14 shows a cross-section view of a second particular embodiment of a microchannel 1400. In this embodiment, a porous substrate 1405 is inserted into a cavity 1410 formed inside a processed material 1415 fixed on a substrate 1420 by cutting the material 1415 and inserting the porous substrate 1405 into the cut made. In some variants, the microchannel 1400 is fixed permanently to the porous substrate 1405. This permanent fixing is achieved, for example, by molding the material 1415 around the porous substrate 1405. This fixing can be achieved, for example, by gluing the porous substrate 1405 to the material 1415.

The purpose of putting a microchannel and a porous substrate into contact is to be able to transfer a liquid sample from one system to the other. The contact can be maintained by tools for maintaining a certain impermeability, for example fixing clips as described in FIG. 11.

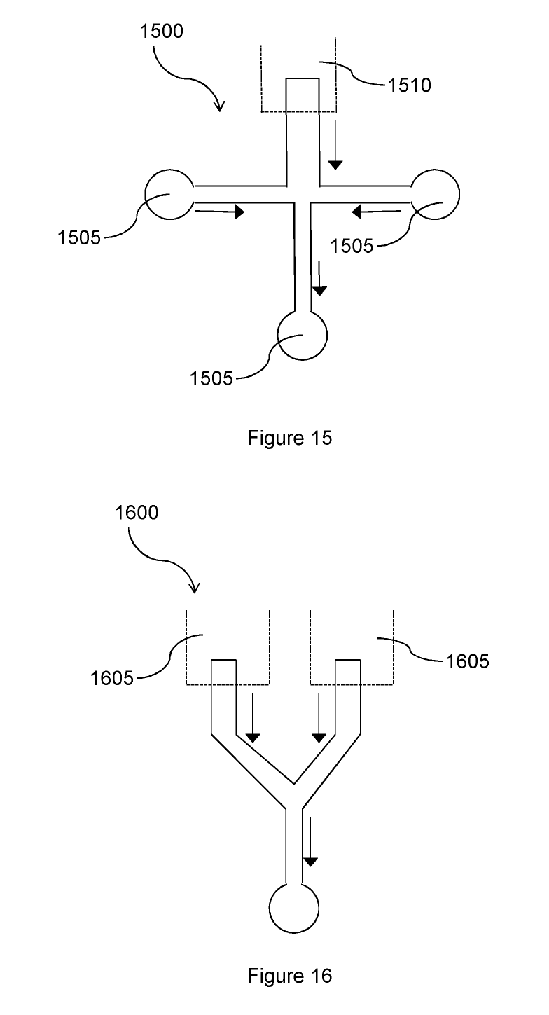

FIG. 15 shows, seen from above, a microchannel 1500 comprising a plurality of means 1505 of receiving a fluid, each fluid being directed according to the pressure applied to the fluid.

FIG. 16 shows, seen from above, a microchannel 1600 comprising a plurality of porous substrates 1605, each containing at least one fluid, each fluid being drawn into the microchannel 1600 by regulating the internal pressure of the microchannel 1600.

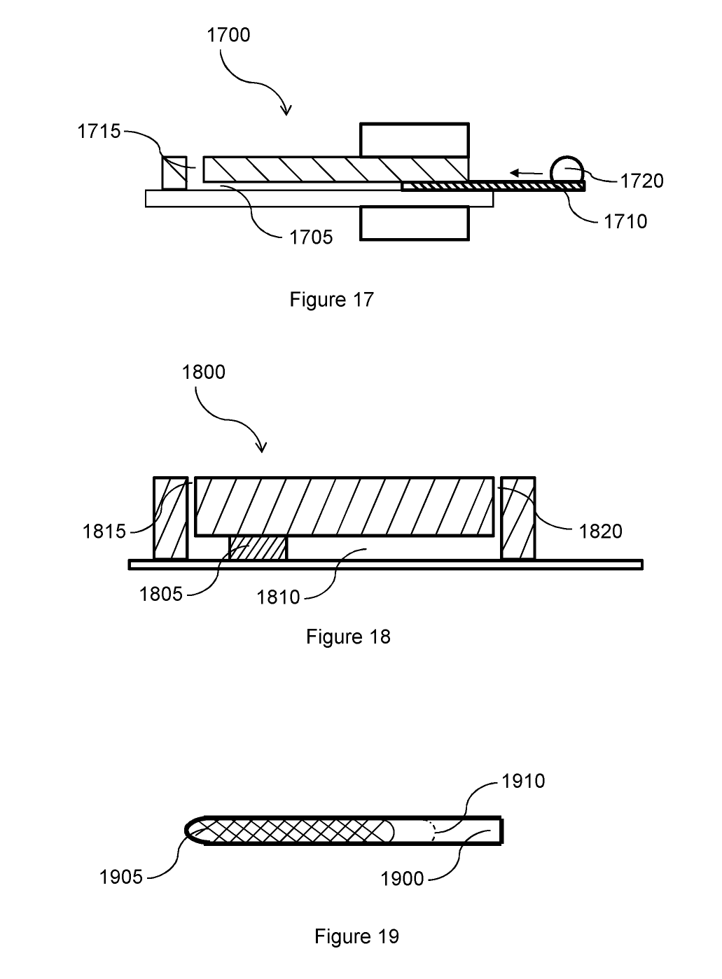

FIG. 17 shows, seen in cross-section, a particular embodiment of a kit for restituting analyte 1700. This analyte restitution kit 1700 comprises a microchannel 1705 and a porous substrate 1710 comprising dried analytes. Dried analytes are obtained by evaporating a solvent transporting the analytes through a porous substrate 1710. The porous substrate 1710 is put into contact with the microchannel 1705 and a solvent 1720 is injected into the porous substrate 1710. By capillarity, the solvent 1720 spreads into the porous substrate 1710, transporting the dried analytes during its passage. The pressure in the microchannel 1705 is reduced such that the analyte transported by the solvent 1720 enters into the microchannel 1705. This analyte penetrates more or less into the microchannel 1705 according to the pressure exerted.

FIG. 18 shows, seen in cross-section, a particular embodiment of a kit for storing or restituting analytes 1800. In this kit 1800, a porous substrate 1805 is embedded inside a microchannel 1810. The microchannel 1810 comprises two openings 1815, one upstream from the porous substrate 1805 and one downstream from the porous substrate 1805. The insertion into a first opening of a solvent comprising an analyte allows the analyte to be stored in the porous substrate 1805 in a dried way by evaporation of the solvent. To retrieve the analyte, a solvent is entered by one of the openings 1815 of the microchannel 1800 such that the analyte dissolves in the solvent and leaves the microchannel 1800 by the second opening 1815. In this configuration, the porous substrate 1805 serves as a storage matrix.

The dry or wet chemical modification of the surface of the porous substrate 1805 and/or of the microchannel 1810 allows control of the hydrophilic or hydrophobic affinity for the samples used.

When several microchannels are mounted on a substrate, this is known as a “microfluidic chip”. The microchannels of a microfluidic chip have, for example, a length of, for example, between 0.1 nanometer and several centimeters. The channel formed in a porous substrate can have a similar size to that of the microchannel or a very different size, depending on the technical means available.

As an illustration, a microchannel can be produced as follows:

To produce a microchannel, photolithography of a resin deposited on a silicon wafer enables a reusable solid mold to be obtained. A polydimethylsiloxane, abbreviation “PDMS”, type of polymer and a cross-linking agent are mixed and poured over the mold. A step of degassing, in a vacuum during twenty minutes, allows the air bubbles to be extracted, then curing at 70° C. for two hours, ensures good cross-linking of the polymer. The polymer thus molded is then separated from the silicon mold, by slight mechanical deformation, than an inlet is pierced using a punch. The polymer, containing the microchannel, is then glued onto a glass slide by means of a plasma treatment, with oxygen.

The glass slide can have been covered beforehand with a layer of polymer.

A step of drying in a silane atmosphere can precede the gluing of the polymer with the glass slide, to functionalize the surfaces with a chemical group present on the silane.

The PDMS mold can serve as a die for transferring the pattern to a photo-curable adhesive after ultraviolet insolation.

As an illustration, a paper microfluidic chip can be produced as follows:

The paper-based microfluidic system can result from a simple cutting of the substrate. The channels on paper can be defined by wetting contrast. A prior chemical treatment (AKD or silanization type) makes it possible to control the condition of the entire substrate. Ultraviolet insolation or a plasma treatment, localized through a mask made of metal, quartz, resin, chromium, or plastic, for example, or by focalization, allows the condition to be changed locally.

According to another embodiment, the channels on paper can be defined by solidification in situ of a compound allowing the pores of the porous substrate to be blocked: such as a wax, a polymer, a resin. The localization of these barriers can result from a specific insolation (photolithography) or by a precise deposit (e.g. solid ink printer). The formation of hollowed-out microstructures, for example by a laser, can also make a form of barrier.

The paper support can also have been incised so as to form a single channel rather than a wetting porous medium.

Putting the microchannel and porous substrate in contact is achieved, for example, as follows:

The paper-based microfluidic system and the microchannel can be put into contact by specifically detaching the two constituent layers composed of the material and the substrate by means of a scalpel. Depending on the manufacturing methods, the layers are of polymer, polymer-glass, photocurable adhesive-glass, or photocurable adhesive type. The porous substrate is then slipped between the two constituent layers. A fixing clip is positioned so as to exert pressure on both sides of the two constituent layers to reestablish impermeability.

The porous substrate can also be slipped into a horizontal, vertical or oblique notch made in the polymer forming the microchannel. Putting the microchannel and porous substrate in contact can be achieved during the production of the microchannel by slipping the porous substrate between the two constituent layers before or during the gluing step, or by molding a portion of the microchannel around the porous substrate.

During the flow from a microchannel to a porous substrate, the analytes dissolved in a solvent have different affinities with the porous substrate depending on steric, chromatographic, physical or chemical criteria linked to the size of the molecules, the electrostatic properties of the analytes, covalent bonds or Van der Waals bonds, for example. The flow speed of the analytes in the porous substrate can be different from that of the solvent, or zero. FIG. 19 shows a porous substrate 1900 comprising an injection-retrieval zone 1905 on which a solvent comprising dissolved analytes is deposited. FIG. 19 shows, in particular, the case in which the flow speed of the analytes is less than the flow speed of the solvent. In this configuration, the solvent forms a solvent front 1910 and the position of the analytes is limited to between this solvent front 1910 and the injection-retrieval zone 1905. FIG. 20 shows a porous substrate 2000 as described in FIG. 19 in which the flow speed of the analytes is zero. In this configuration, the analytes remain at the location of the injection-retrieval zone 2005.

Evaporation of the solvent is present naturally because of the large free air/liquid interfaces, the microfluidic channels being open. In addition, an enrichment method, which consists of performing several successive deposits of solvent in which analytes are dissolved, separated by wait times to allow the evaporation, provides a concentration effect increasing the quantity of analyte deposited. This phenomenon is advantageous from the time when the injection-retrieval zone is checked, for example with a view to a selective restitution or a reaction for which the position is specific.

In the case of an analyte transported well by the solvent, when a deposit is made on a porous substrate, inside a pattern made in a wax barrier, by wetting contrast or any other production method, the capillary pump draws the liquid over the entire accessible volume of the porous medium. The effect is limited by the final sample volume deposited. Therefore, a drop deposited at the inlet of a channel must present a liquid front that advances and draws an analyte of interest thanks to the solvent deposited. When this deposit is dried, the analyte is almost uniformly distributed over the entire zone reached by the sample. A Marangoni effect can be noted, which favors the deposits on the edges of the porous substrate, because of the tension gradient, due to the non-uniform evaporation of the solvent. In the case of a rough surface, or a porous medium, this phenomenon is limited. By adding a drop of solvent at the inlet of the right channel, on which the analyte is dried, the solvent is again dissolved and transported by the flow. By one or several additions, the initially uniformly dried analyte can be transported up to the extremity of the flow. FIG. 21 shows, in particular, a porous substrate 2100 comprising an injection-retrieval zone 2105 of solvent comprising an analyte 2110 of interest. This analyte 2110, with the solvent, moves by capillarity in the porous substrate 2100 until the solvent evaporates. FIG. 22 shows the porous substrate 2100 described in FIG. 21, in which solvent has been added on the injection-retrieval zone, so as to move the analyte 2110 over the porous medium.

Successive deposits of solvent make it possible, in particular, to increase the local concentration of analyte. In effect, in as much as the solvent evaporates, through a controlled dosage, always at the same location of the porous substrate, it makes it possible to transport the analytes to this location. FIG. 23 shows a graph representing the local concentration of analyte as a function of the number of successive deposits of solvent on the injection-retrieval zone of a porous substrate. It is noted, in particular, that the concentration of analyte increases until a saturation threshold is reached, which depends upon the total quantity of analyte deposited.

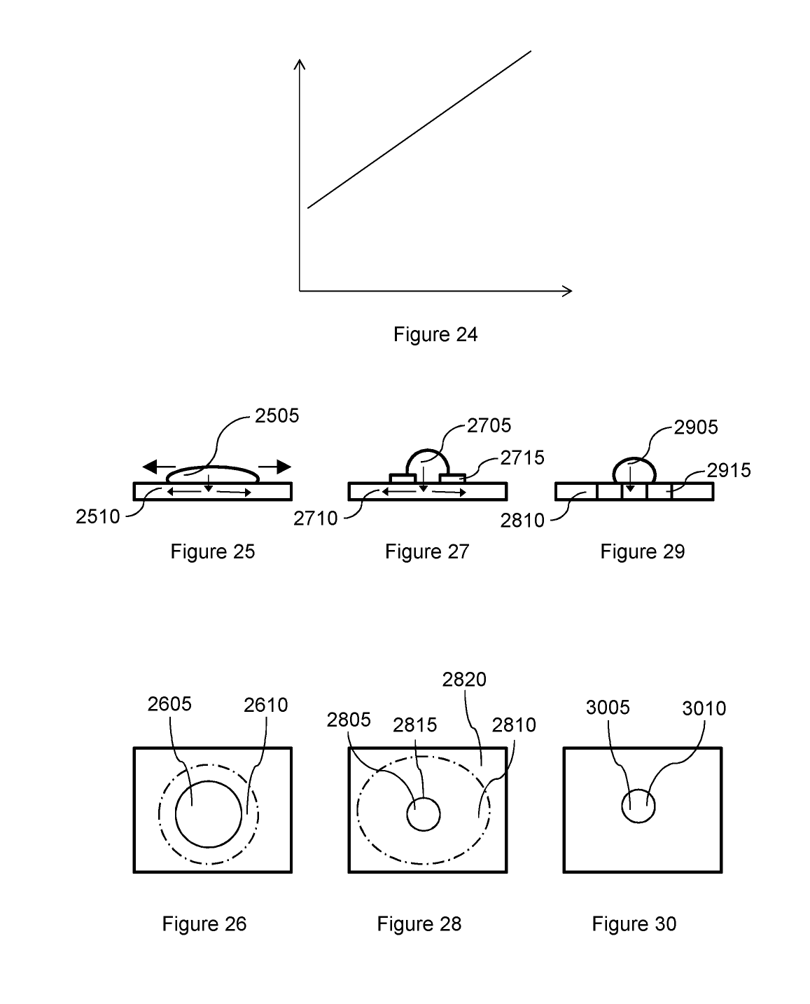

To combine this concentration method with an enrichment technique, it is just necessary to make one or more deposits of samples, separated by a drying time, followed by one or more additions of solvents that perform the final transport. This process is similar to the one illustrated in FIGS. 21 and 22, except that instead of one deposit being made on the injection-retrieval zone of the porous substrate, a plurality of deposits is made. The accumulation of a plurality of deposits of analyte and a plurality of deposits of solvent makes it possible to significantly increase the local concentration of analyte at the point of the concentration. FIG. 24 shows a graph of the local concentration of an analyte of interest as a function of the volume of deposits of solvent comprising an analyte of interest on the injection-retrieval zone and of the volume of solvent deposited in the injection-retrieval zone.

In the case of an analyte retained well by the porous matrix of the porous substrate, the method consists of limiting the spread of the drop on the surface to restrict the injection-retrieval zone while allowing the capillary pump to extract the solvent. With no barriers, the drop spreads over a large surface area. With barriers in the entire thickness of the porous substrate, the drop is retained well spatially but the evaporation time is long because the drop remains in the shape of a spherical cap. With barriers at the surface or in a partial thickness of the porous substrate, the drop does not spread, therefore the injection-retrieval zone is restricted, and the capillary pump allows the solvent to be extracted. The drop is transformed into a thin film, which has a much shorter evaporation time. FIG. 25 shows a cross-section view of a particular embodiment of a deposit of a drop 2505 of a solvent comprising an analyte on a porous substrate 2510 comprising no barrier. FIG. 26 shows a top view of the deposit illustrated in FIG. 25. This FIG. 26 shows, in particular, that the injection-retrieval zone of the analyte 2605 and the injection-retrieval zone of the solvent 2610 have almost the same size. In this configuration, the solvent evaporates quickly but the injection-retrieval zone of the analyte is large.

FIG. 27 shows a cross-section view of a particular embodiment of a deposit of a drop 2705 of a solvent comprising an analyte on a porous substrate 2710 comprising barriers 2715 at the surface. FIG. 28 shows a top view of the deposit illustrated in FIG. 27. This FIG. 28 shows, in particular, that the injection-retrieval zone of the analyte 2805, delimited by the barrier 2815 forming an enclosed surface area, is much smaller than the injection-retrieval zone of the solvent 2810, which is not limited by the barrier. In this configuration, the solvent evaporates quickly and the injection-retrieval zone of the analyte is small.

FIG. 29 shows a cross-section view of a particular embodiment of a deposit of a drop 2905 of a solvent comprising an analyte on a porous substrate 2910 comprising barriers 2915 in the thickness of the porous substrate. FIG. 30 shows a top view of the deposit illustrated in FIG. 29. This FIG. 30 shows, in particular, that the injection-retrieval zone of the analyte 3005 is of a similar size to the size of the injection-retrieval zone of the solvent 3010. In this configuration, the solvent evaporates slowly but the injection-retrieval zone of the analyte is small.

By repeating the method of deposit on a porous substrate comprising surface barriers a large number of times, a large quantity of analyte can be deposited on the injection-retrieval zone in a fairly short period of time because of the short evaporation time. The concentration of analyte deposited therefore increases linearly with the volume of sample deposited.

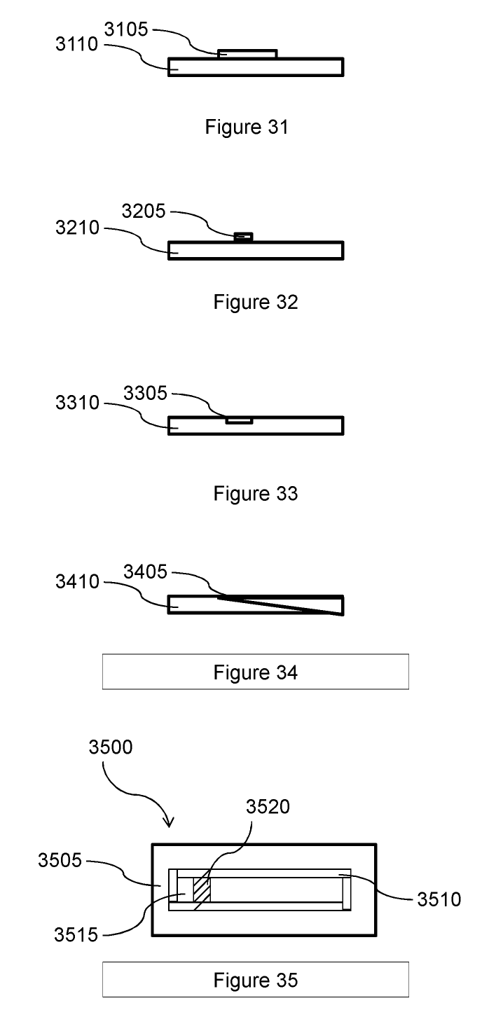

This barrier can be produced with many production methods. For example, a piece of adhesive tape meets all the criteria, having good adherence on the porous medium and a hydrophobic surface that contrasts with the hydrophilic porous medium. Using heated wax allows barriers to be formed in situ in the entire thickness of the porous substrate. By limiting the amount of wax deposited or the heating time, the distribution of the wax can be reduced and a barrier can be obtained in a partial thickness of the porous substrate. It is also possible to obtain a barrier at the surface or in a partial thickness by cross-linking polymer or resin or by wetting contrast. FIG. 31 shows a cross-section view of a particular embodiment of a barrier 3105 on a porous substrate 3110 in which the barrier is a hydrophobic adhesive tape. FIG. 32 shows a cross-section view of a second particular embodiment of a barrier 3205 on a porous substrate 3210 in which the barrier is a small amount of wax deposited on the porous substrate 3210. FIG. 33 shows a cross-section view of the second particular embodiment of a barrier 3305 as described in FIG. 32 in which the wax has been heated so as to penetrate a porous substrate 3310 to form a barrier in it.

FIG. 34 shows a cross-section view of a third particular embodiment of a barrier 3405 whose thickness varies in the porous substrate 3410. In this configuration, the concentration of analyte is realized both in the direction of flow and transversally in the porous substrate.

In order for operations to be paralleled, it is possible to combine the two concentration systems described above, i.e. for the case where an analyte is bound and the case where an analyte moves easily with the solvent. In this case, the device comprises an injection-retrieval zone, delimited at least partially by a barrier, and one or more extremities. The sample used contains at least two analytes: one retained well by the porous substrate, the other transported well by the flow. The sample is deposited in one or more volumes on the injection-retrieval zone, then one or more volumes of solvent are added. The compound retained well is concentrated before the surface barrier; the transported compound is deposited on the extremity. With a single system, the separation and concentration steps are carried out simultaneously. It is also possible to use a plurality of analytes moving with the solvent at different speeds so as to separate and spatially concentrate several analytes with a single device.

FIG. 35 shows a particular embodiment of a device 3500 for separating and spatially concentrating a plurality of analytes that comprises a porous substrate 3505 in which barriers 3510 in the entire thickness of the porous substrate make it possible to guide the flow. This device 3500 also comprises an injection-retrieval zone 3515 for a plurality of analytes dissolved in one or more solvents delimited by a barrier 3520 on the surface or over a partial thickness for realizing the separation or concentration. By depositing the solvent or solvents comprising the analytes on the injection-retrieval zone, these analytes are transported by their respective solvent through the porous substrate 3505 according to their particular characteristics of movement in a substrate.

A method of concentrating a sample transported by flowing in a porous medium can be realized as follows:

The method of concentrating a sample transported well by flow comprises a step of depositing the sample followed by additions of solvent—water in the case of hydrophilic compounds. The porous substrate is treated with a wetting contrast, or solid barriers, or a cut, or any other production method, so as to have a geometry of a type with a channel closed at the extremity. It can also have an injection-retrieval zone connected to the channel.

A volume of sample is deposited on the injection-retrieval zone. The liquid flows in the entire geometry accessible, thanks to the capillary pump. The large free interfaces between the liquid and the air facilitate evaporation. The analyte dissolved in the solvent is then deposited in dried form over the entire accessible surface of the porous medium. By adding a volume of solvent, the analyte is dried and again dissolved and transported over a certain distance before being deposited in dried form again. By repeating this operation a certain number of times, the entire analyte can be transported and deposited up to the extremity, thus minimizing the analyte deposit zone, hence the concentrator effect. The volume of solvent required depends on the porosity of the porous and the geometry of the channel.

For an increased concentration effect, it is possible to perform several deposits of samples before adding the deposits of solvent.

A method of concentrating a sample retained in a porous medium can be realized as follows:

The method of concentrating a sample retained well by the porous medium comprises several successive deposits of sample. The porous substrate comprises an injection-retrieval zone delimited by a barrier. This barrier can be realized by a piece of adhesive tape or by depositing a small quantity of wax.

The sample is deposited on the injection-retrieval zone. The capillary pump extracts the solvent, and evaporation is quick thanks to this extraction. Once the sample is dried, it is possible to perform the next deposit. By repeating this step a large number of times, a large quantity of analyte of interest can be brought together on the injection-retrieval zone, hence the concentration effect.

1-38. (canceled)

39. A method for storing and concentrating at least one non-volatile compound contained in a fluid, the fluid additionally comprising at least one volatile compound, comprising the steps of:
injecting the fluid into a porous substrate for at least one volatile compound;
transporting at least one non-volatile compound, at least by capillarity, by said at least one volatile compound;
concentrating each transported non-volatile compound by:
injecting said at least one volatile compound into or onto the porous substrate to move said each transported non-volatile compound from one point of the porous substrate to another; and
for each step of injecting said at least one volatile compound, drying said each transported non-volatile compound at one point of the porous substrate by evaporating each volatile compound.

40. The method according to claim 39, further comprising, downstream from the concentration step, the step of reacting said at least one non-volatile compound with at least one reagent, each reagent being configured to react with each non-volatile compound

41. The method according to claim 39, wherein said at least one reagent is configured to modify, during the reaction step, transport properties of said at least one non-volatile compound.

42. Method according to claim 39, wherein at least one portion of the porous substrate comprises a different fibrous density than the rest of the porous substrate.

43. Method according to claim 42, wherein the porous substrate comprises a density gradient of fibers along an axis of the porous substrate.

44. Method according to claim 39, wherein the porous substrate comprises, over at least one portion of a surface of the porous substrate, a barrier configured to be non-porous for said at least one non-volatile compound, the porous substrate, including under the barrier, being configured to be porous for said at least one volatile compound.

45. A support for storing and concentrating at least one non-volatile compound contained in a fluid, the fluid additionally comprising at least one volatile compound, comprising:
a porous substrate;
a barrier over at least one portion of a surface of the porous substrate, the barrier being configured to be non-porous for said at least one non-volatile compound;
the porous substrate, including under the barrier, being porous for said at least one volatile compound, including under a barrier; and
said at least one non-volatile compound being concentrated by said at least one volatile compound flowing in the porous substrate.

46. The support according to claim 45, wherein the barrier is positioned at least partially in the porous substrate.

47. The support according to claim 45, wherein the barrier is an adhesive tape that is non-porous for said at least one non-volatile compound.

48. The support according to claim 45, wherein the barrier is a polymer or a resin solidified on the surface of the porous substrate.

49. The support according to claim 45, wherein the barrier is a wax melted and solidified on the surface of the porous substrate.

50. The support according to claim 45, wherein the barrier is obtained by a local contrast in a wetting property of the porous substrate.

51. The support according to claim 45, wherein the barrier forms a transport channel for each non-volatile compound.

52. The support according to claim 51, wherein the transport channel is configured such that each non-volatile compound is transported, at least by capillarity, by said at least one volatile compound along the transport channel; and wherein the transport channel is configured such that said each non-volatile compound is concentrated in different points of the porous substrate by evaporation of each volatile compound.

53. The support according to claim 45, wherein the porous substrate comprises, in at least one point, a reagent configured to react with said at least one non-volatile compound.

54. The support according to claim 53, wherein the porous substrate comprises a plurality of reagents, at least two reagents not in contact with each other.

55. The support according to claim 45, wherein the barrier is configured to increase in thickness along an axis of the porous substrate to realize a transversal concentration of said each non-volatile compound in the porous substrate.

56. A device comprising the support according to claim 45; and an injector to inject the fluid onto the porous substrate, the injector configured to perform a plurality of injections successively to concentrate at a same point of the porous substrate different quantities of a same non-volatile compound.

57. A device comprising the support according to claim 45; and an injector to inject the fluid onto the porous substrate, the injector configured to perform a plurality of injections of different fluids, including at least one fluid that comprises said at least one non-volatile compound, onto the porous substrate to concentrate different non-volatile compounds at different points of the porous substrate, or to move said at least one non-volatile compound from one point of the porous substrate to another.
